(19) United States
(12) Patent Application Publication
(10) Pub. No.: US 2013/0003367 A1
(43) Pub. Date: Jan. 3, 2013

(54) ILLUMINATION DEVICE

(75) Inventors: QING-SHAN CAO, Shenzhen City (CN); ZHENG-NIAN LIU, Shenzhen City (CN); JIAN-PU CHEN, Shenzhen City (CN); JIANG-FAN QIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/301,800

(22) Filed: Nov. 22, 2011

(30) Foreign Application Priority Data
Jun. 29, 2011 (CN) 201110178464.8

(51) Int. Cl. F21V 21/00

(52) U.S. Cl. 362/217.16

(57) ABSTRACT

An illumination device includes a light tube holder including two connectors for receiving either a light-emitting diode (LED) tube or a fluorescent tube. One of the connectors includes a rotary member rotatably received in a through hole defined in a retainer, and three conductive elastic pieces positioned in the retainer around the through hole. One conductive piece is electrically connected to an LED tube drive circuit board and a fluorescent tube drive circuit board, and the other two conductive pieces are electrically connected to the LED and fluorescent tube drive circuit boards, respectively. The rotary member can be rotated to first and second positions, wherein at the first position, the LED tube can be activated, and at the second position the fluorescent tube can be activated.

### CROSS-REFERENCES TO RELATED APPLICATIONS

Related subject matter is disclosed in co-pending U.S. patent applications with an Attorney Docket Number US39861 and a title of LIGHT TUBE HOLDER, an Attorney Docket Number US39862 and a title of ILLUMINATION DEVICE, an Attorney Docket Number US39864 and a title of ILLUMINATION DEVICE, an Attorney Docket Number US39865 and a title of ILLUMINATION DEVICE, an Attorney Docket Number US39866 and a title of ILLUMINATION DEVICE, and an Attorney Docket Number US40306 and a title of ILLUMINATION DEVICE, which have the same assignees as the current application and were concurrently filed.

### BACKGROUND

1. Technical Field

The present disclosure relates to illumination devices, and particularly, to a light-emitting diode (LED) illumination device for adapting a LED tube and a fluorescent tube.

2. Description of the Related Art

Generally, a conventional light tube holder for fluorescent tubes can not be used with LED tubes. When attempting to use an LED tube, the conventional light tube holder needs to be replaced. It is desirable and useful if a light tube holder can adapt to both fluorescent tubes and LED tubes.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an illuminating device in accordance with an exemplary embodiment.

FIG. 2 is an exploded view of the illuminating device in FIG. 1.

FIG. 3 is an exploded view of a connector of the illuminating device in FIG. 1.

FIG. 4 is an isometric view of a retainer of the connector of the illuminating device in

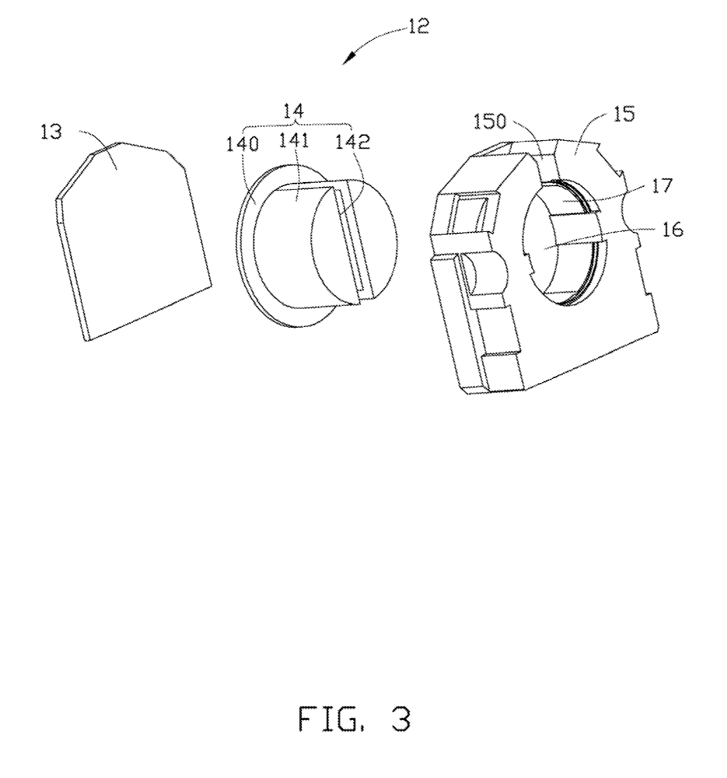

FIG. 3 according to a first exemplary embodiment.

FIG. 5 is an isometric view of the retainer of the connector of the illuminating device in FIG. 3 according to a second exemplary embodiment.

FIG. 6 is an isometric view of the retainer of the connector of the illuminating device in FIG. 3 according to a third exemplary embodiment.

FIG. 7 is an isometric view of the retainer of the connector of the illuminating device in FIG. 3 according to a fourth exemplary embodiment.

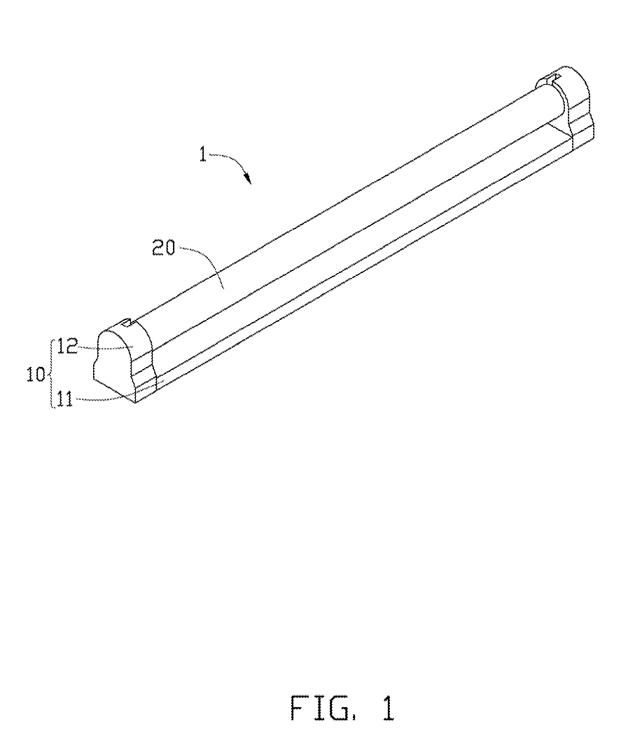

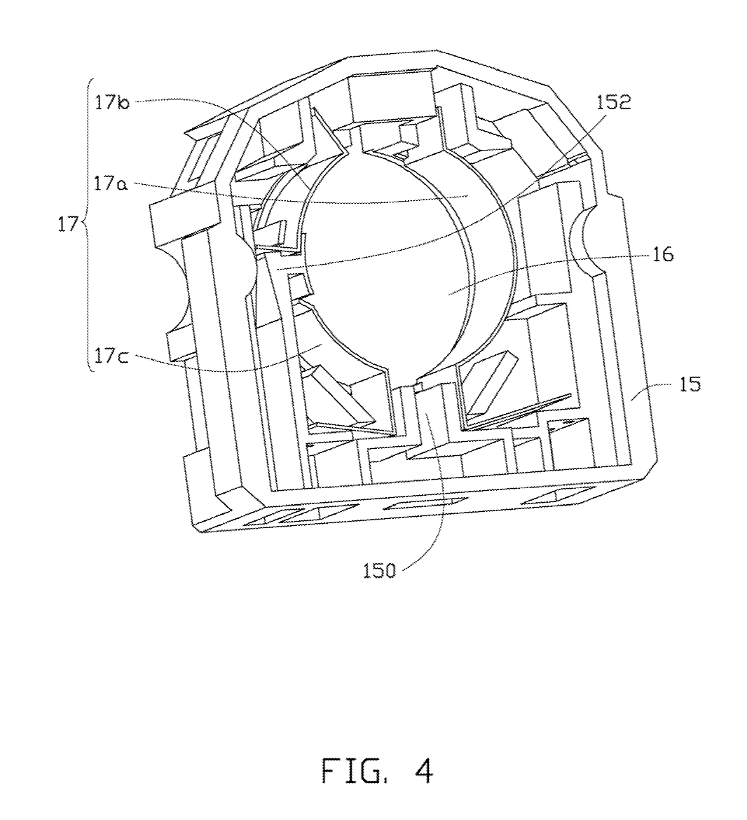

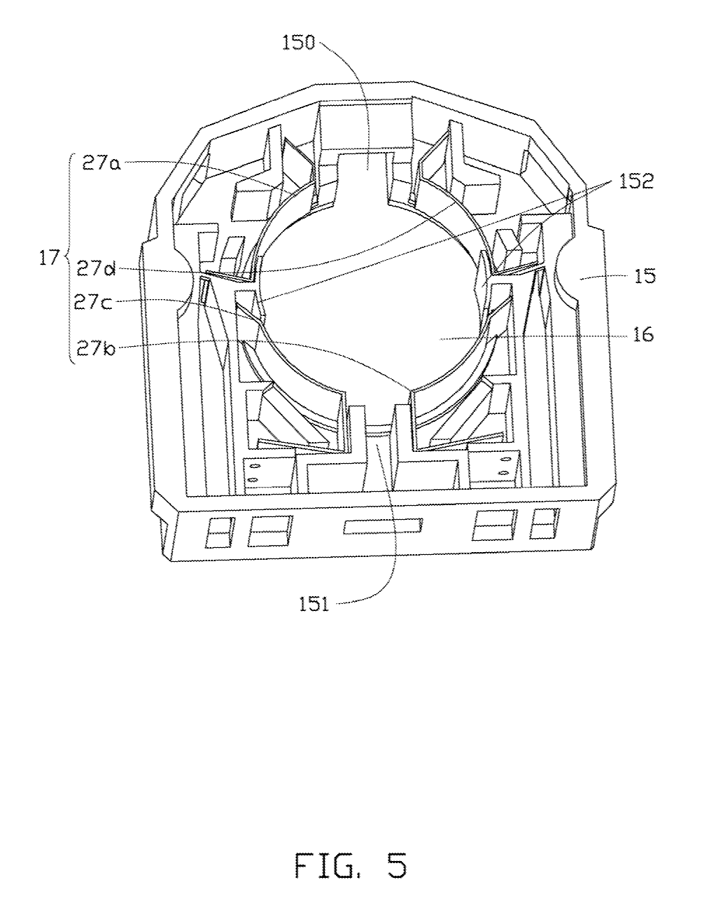

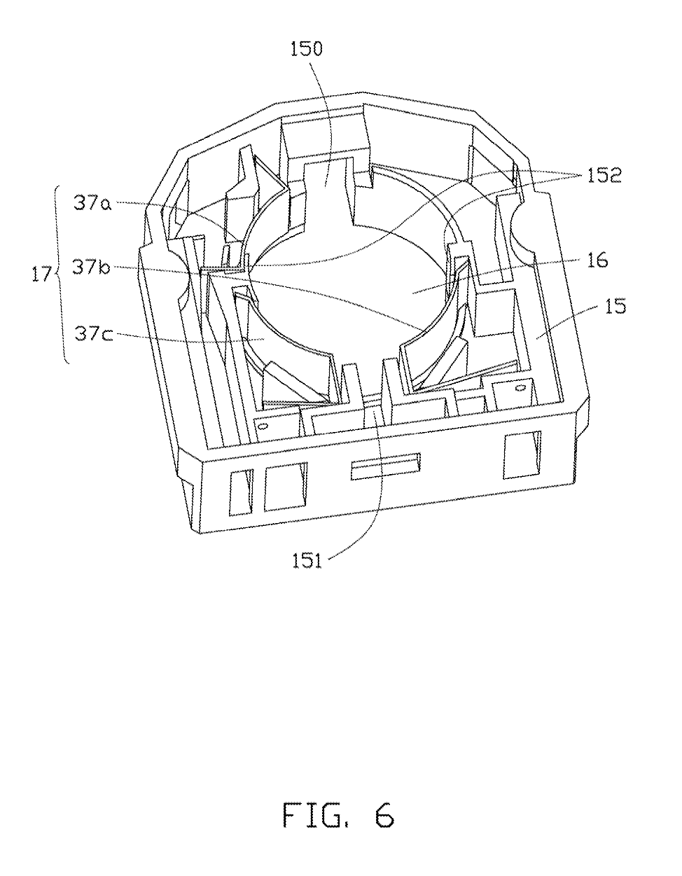

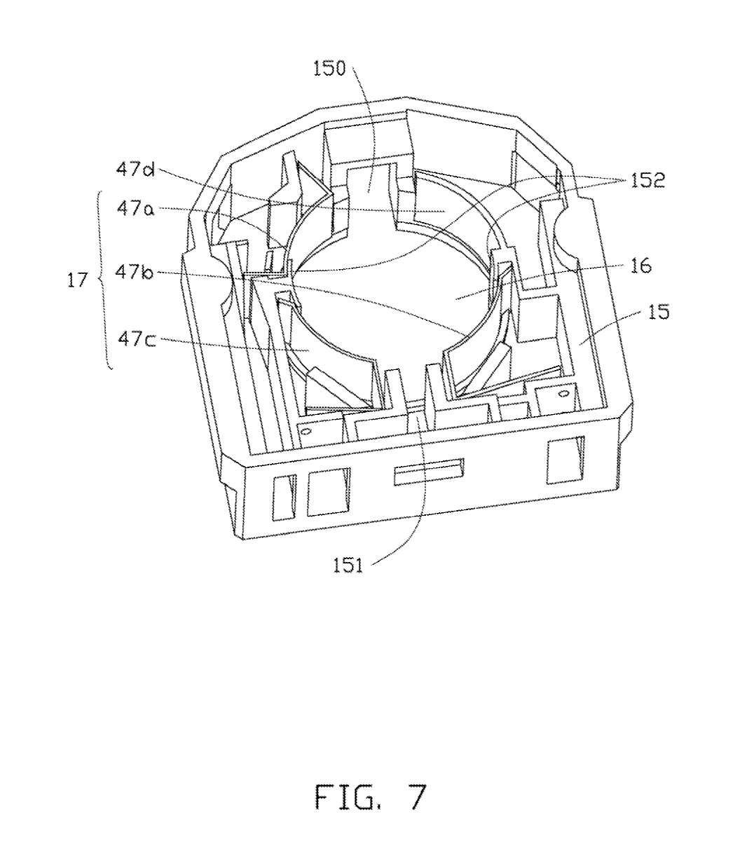

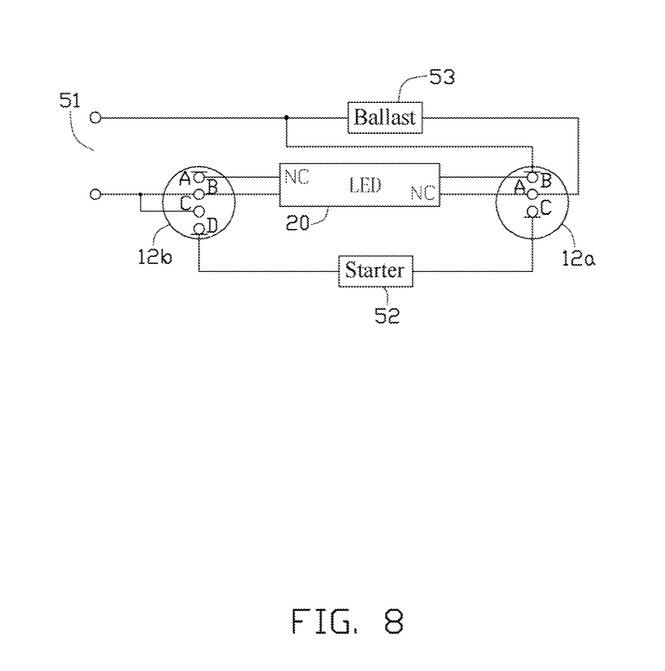

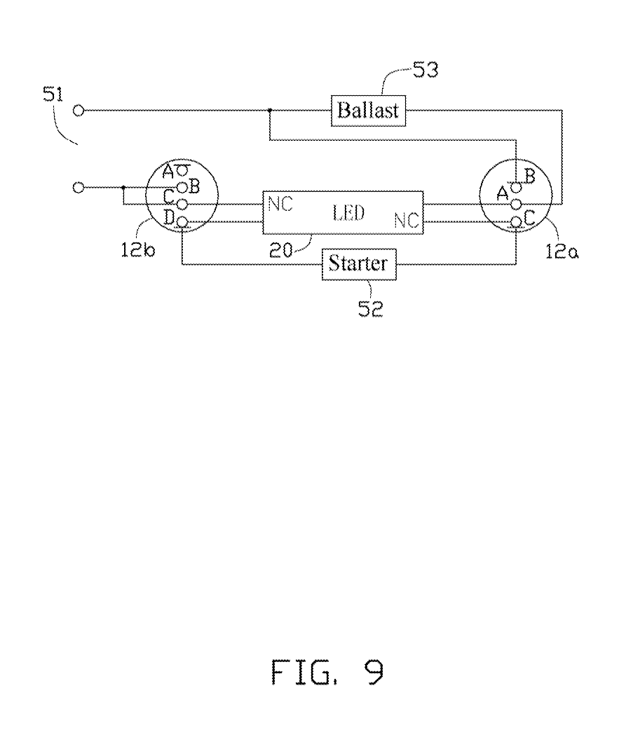

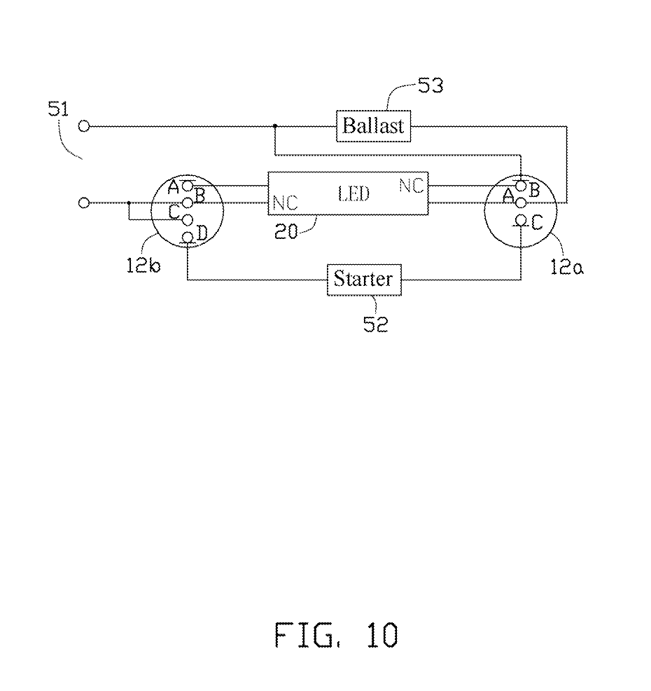

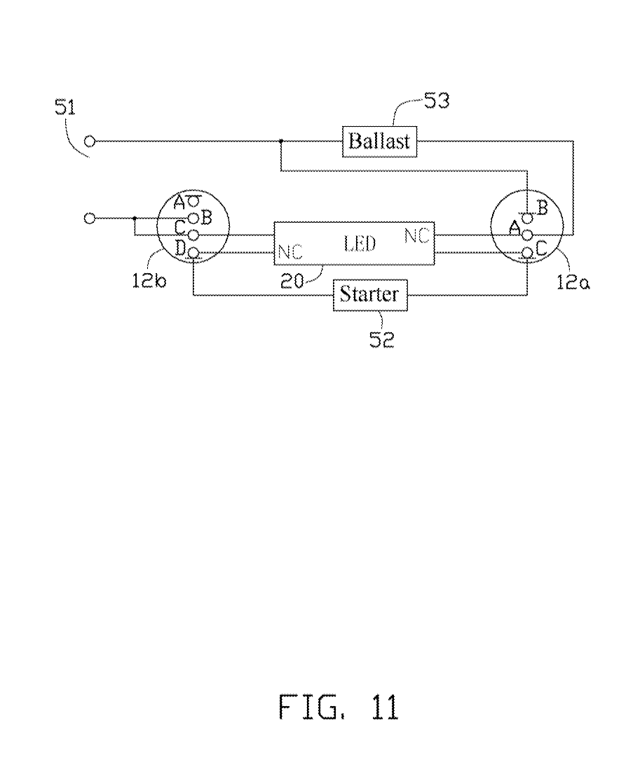

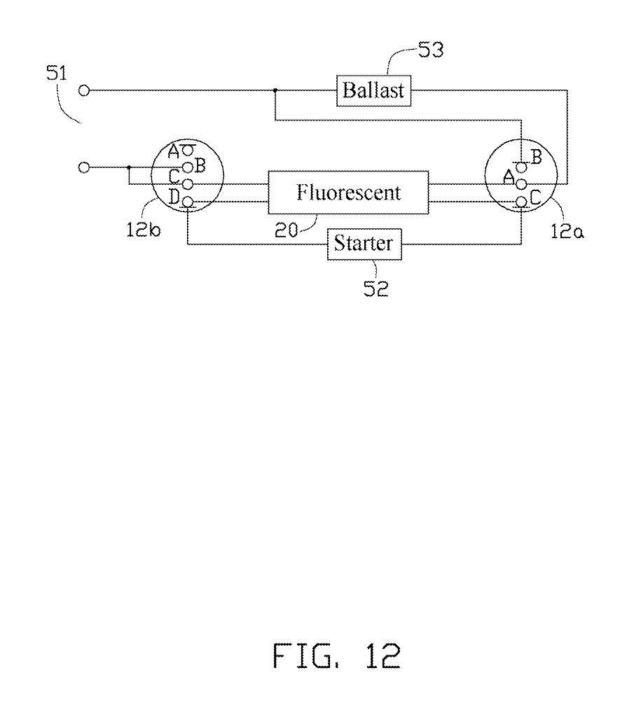

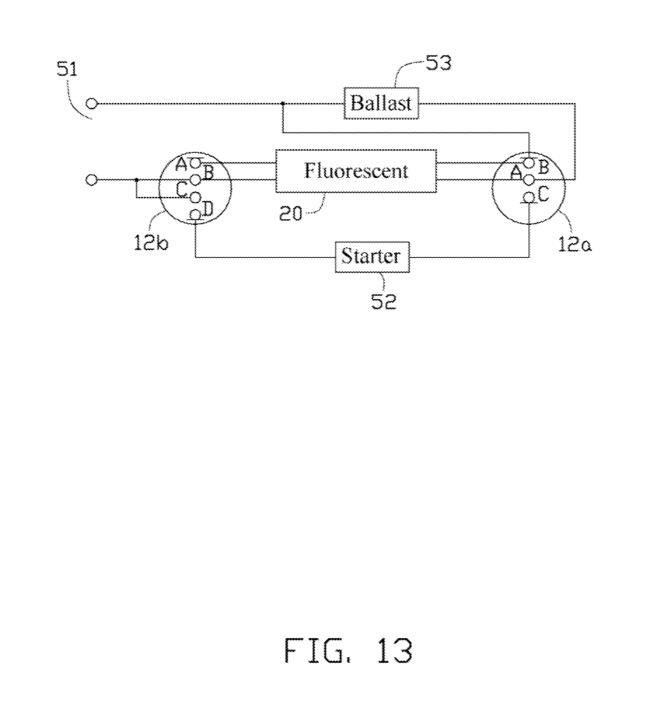

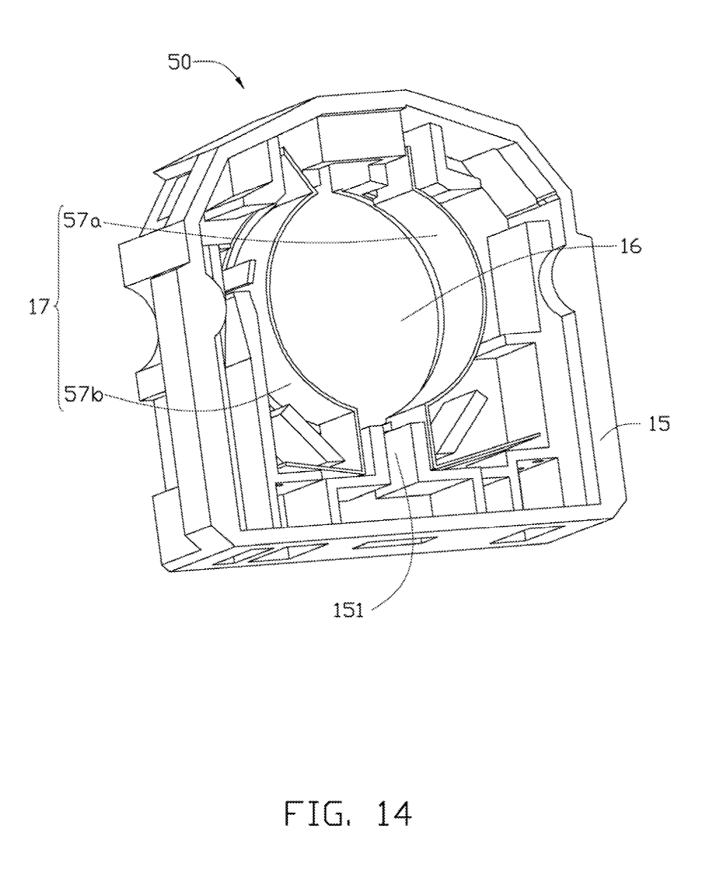

FIG. 8 is a circuit diagram of the LED illumination device in FIG. 1, illustrating a LED tube connected to the connector in FIG. 4 and the connector in FIG. 5 according to a first exemplary embodiment.

FIG. 9 is a circuit diagram of the illumination device in FIG. 1, illustrating the LED tube connected to the connector in FIG. 4 and the connector in FIG. 5 according to a second exemplary embodiment.

FIG. 10 is a circuit diagram of the illumination device in FIG. 1, illustrating the LED tube connected to the connector in FIG. 4 and the connector in FIG. 5 according to a third exemplary embodiment.

FIG. 11 is a circuit diagram of the illumination device in FIG. 1, illustrating the LED tube connected to the connector in FIG. 4 and the connector in FIG. 5 according to a fourth exemplary embodiment.

FIG. 12 is a circuit diagram of the illumination device in FIG. 1, illustrating a fluorescent tube connected to the connector in FIG. 4 and the connector in FIG. 5 according to a first exemplary embodiment.

FIG. 13 is a circuit diagram of the illumination device in FIG. 1, illustrating the fluorescent tube connected to the connector in FIG. 4 and the connector in FIG. 5 according to a second exemplary embodiment.

FIG. 14 is an isometric view of a connector for a conventional fluorescent tube.

### DETAILED DESCRIPTION

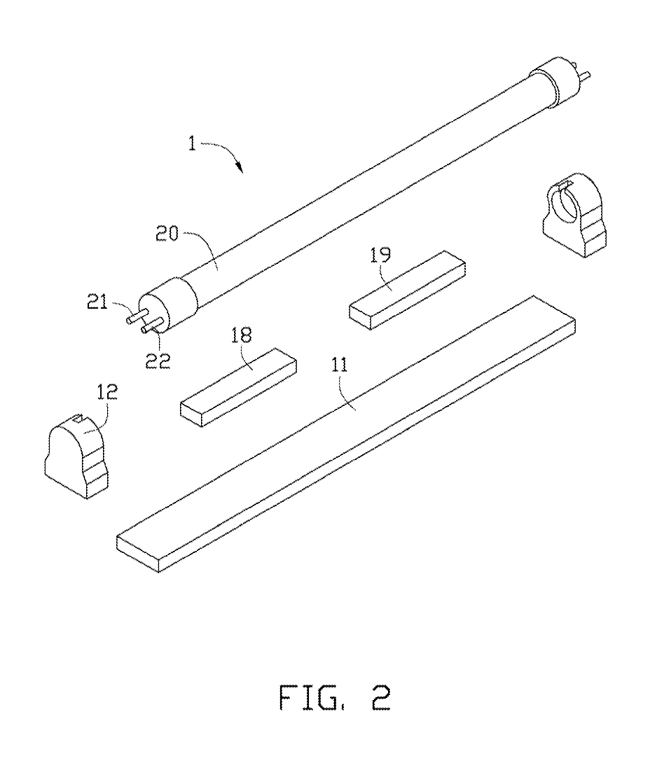

Referring to FIGS. 1-3, an illuminating device 1 includes a tube holder 10 and a tube 20 mounted on the tube holder 10. The tube 20 in FIGS. 1 and 2 is a light-emitting diode (LED) tube 20. A conductive pin 21 and an insulated pin 22 are arranged on each end of the LED tube 20. A conductive pine 21 at one end is diagonally opposite to the other conductive pin 21 on the other end of the LED tube 20. The tube 20 also can be a traditional fluorescent tube which has two conductive pins on one end thereof and two conductive pins on an opposite end thereof.

The tube holder 10 includes a base 11 and connectors 12 at opposite ends of the base 11. Each connector 12 includes a cap 13, a retainer 15, and a rotary member 14. The cap 13 is attached to one end of the retainer 15. The cap 13 and the retainer 15 cooperatively define a space to receive the rotary member 14 therein. In the embodiment, a through hole 16 is defined in the retainer 15. The rotary member 14 is smaller in diameter than the though hole 16, thereby allowing the rotary member 14 to be received and to rotate in the through hole 16. The rotary member 14 is in the shape of a hat, including a brim 140, a body 141, and a first groove 142. The brim 140 is larger in diameter than the though hole 16, and abuts the outside end face of the retainer 15 around the though hole 16. The first groove 142 is diametrically defined in the body 141 and divides the body 141 into two substantially equal parts. The first groove 142 can receive the two pins of the tube 20 therein. An opening 150 is defined in the retainer 15, on a line substantially perpendicular to, and furthest from, the base 11, and extends from an external surface of the sidewall of the through hole 16, and communicates with the through hole 16.

Referring to FIG. 4, an elastic member 17 consisting of three elastic pieces 17a, 17b, 17c is positioned in the retainer 15 around the through hole 16. Each elastic piece 17a, 17b, 17c is made of an elastic metal sheet by stamping. The elastic piece 17a has a configuration of a half of a circle, while each of the elastic pieces 17b, 17c has a configuration of one fourth of a circle. A second groove 151 is defined in the retainer 15 opposite the opening 150. In this embodiment, at least one buffer pad 152 is formed on the side wall between the opening 150 and the second groove 151. The opening 150, the second groove 151, and the at least one buffer pad 152 are used to separate the three elastic pieces 17a, 17b, 17c of the elastic member 17 from each other. The three elastic pieces 17a, 17b, 17c of the elastic member 17 can then be electrically insulated from each other. The tube holder 10 further includes a LED tube drive circuit board 18 and a fluorescent tube drive circuit board 19 mounted in the base 11. The elastic pieces 17a, 17b are connected to the LED tube drive circuit board 18 and the elastic pieces 17a, 17c are connected to the fluorescent tube drive circuit board 19.

When installing the tube 20, the rotary member 14 is first rotated to cause the first groove 142 to align with the opening 150. The pins 21 of the tube 20 can then be inserted into the through hole 16 and supported in the first groove 142. The tube 20 can then be rotated to misalign the first groove 142 of the rotary member 14 with the opening 150, and securely retain the tube 20 in the retainer 15.

When the tube 20 is rotated to a predetermined position (indicated by a mark (not shown) on the connector 12), the rotary member 14 is rotated to a first position where the pins 21 of the tube 20 make contact with the elastic pieces 17a, 17b of the elastic member 17. Thus, the tube 20 can be driven by the LED tube drive circuit board 18. When the element 14 is rotated to a second position, the pins 21 of the tube 20 make contact with the elastic pieces 17a, 17c of the elastic member 17, allowing the tube 20 to be driven by the fluorescent tube drive circuit board 19. By virtue of these arrangements, the tube holder 10 can well adapt to any type of the tube 20.

In the first embodiment, the elastic member 17 includes three elastic pieces 17a, 17b, and 17c. The length of the elastic piece 17a is about 0.5 A, where A represents the perimeter of the through hole 16. The lengths of the elastic pieces 17b and 17c are both 0.25 A. The number of the at least one buffer pad 152 is one. Thus, the elastic pieces 17a, 17b, and 17c are separated from each other by the opening 150, the second groove 151 and the buffer pad 152.

In an alternative embodiment, the elastic pieces 17a and 17b may be connected to the fluorescent tube drive circuit board 19, and the elastic pieces 17a and 17c may be connected to the LED tube drive circuit board 18.

Referring to FIG. 5, in a second embodiment, there are four elastic pieces 27a, 27b, 27c, and 27d constituting the elastic member 17. The lengths of the four elastic pieces 27a, 27b, 27c, and 27d are all 0.25 A. The number of the at least one buffer pad 152 is two. Thus, the elastic pieces 27a, 27b, 27c, and 27d are separated from each other by the opening 150, the second groove 151 and the two buffer pads 152.

In the embodiment, the elastic pieces 27a and 27b are connected to the LED tube drive circuit board 18, and the elastic pieces 27c and 27d are connected to the fluorescent tube drive circuit board 19. The first position mentioned above is the position where the pins 21 of the tube 20 stay in contact with the elastic pieces 27a and 27b, and the second position mentioned above is the position where the pins 21 of the tube 20 stay in contact with the elastic pieces 27c and 27d.

Referring to FIG. 6, in a third embodiment, there are three elastic pieces 37a, 37b and 37c constituting the elastic member 17. The lengths of the three elastic pieces 37a, 37b, and 37c are all 0.25 A. The number of the at least one buffer pad 152 is two. Thus, the elastic pieces 37a, 37b, and 37c are separated from each other by the opening 150, the second groove 151 and the two buffer pads 152.

In the embodiment, the elastic pieces 37a and 37b are connected to the fluorescent tube drive circuit board 19, and the elastic piece 37c is connected to the LED tube drive circuit board 18. The first position mentioned above is the position where one of the pins 21 of the tube 20 stay in contact with the elastic piece 37c, and the second position mentioned above is the position where the pins 21 of the tube 20 stay in contact with the elastic pieces 37a and 37b.

Referring to FIG. 7, in a fourth embodiment, there are three elastic pieces 47a, 47b, and 47c constituting the elastic member 17. The lengths of the three elastic pieces 47a, 47b, and 47c are all 0.25 A. An insulation piece 47d is positioned in the retainer 15 around the through hole 16. The insulation piece 47d is resilient and has a configuration of a quarter of a circle. The length of the insulation piece 47d is about 0.25 A. The number of the at least one buffer pad 152 is two. Thus, the elastic pieces 47a, 47b, 47c, and the insulation piece 47d are separated from each other by the opening 150, the second groove 151 and the two buffer pads 152.

When installing the tube 20, the rotary member 14 is rotated to a position where the pins 21 of the tube 20 stay in contact with the elastic piece 47c and the insulation piece 47d, the elastic piece 47c and the insulation piece 47d can tightly press against the two pins 21 of the tube 20, thereby holding the tube 20 in position.

In the embodiment, the elastic pieces 47a and 47b are connected to the fluorescent tube drive circuit board 19, and the elastic piece 47c is connected to the LED tube drive circuit board 18. The first position mentioned above is the position where the pins 21 of the tube 20 stay in contact with the elastic piece 47c and the insulation piece 47d, and the second position mentioned above is the position where the pins 21 of the tube 20 stay in contact with the elastic pieces 47a and 47b.

The illumination device 1 may include two connectors 12 of FIG. 4, FIG. 5, FIG. 6, or FIG. 7. Alternatively, the illumination device 1 may include one connector 12a of FIG. 4, and one connector 12b of FIG. 5 (shown in FIGS. 8-13).

Referring to FIGS. 8-11, the elastic pieces 27b and 27c of the connector 12b are connected to the negative terminal of a power supply 51, and the elastic piece 27a of the connector 12b is disconnected from the power supply 51, the ballast 53 and the starter 52. The elastic piece 17a of the connector 12a is connected to the positive terminal of the power supply 51 via a ballast 53, and the elastic piece 17b of the connector 12a is directly connected to the positive terminal of the power supply 51. A starter 52 is connected between the elastic piece 17c of the connector 12a and the elastic piece 27d of the connector 12b.

When installing the LED tube 20, the two pairs of pins 21 and 22 can be inserted into the though holes 16 of the connectors 12a and 12b. The LED tube 20 can be rotated, and when the LED tube 20 is rotated to the first position, the two insulated pins 22 make and stay in contact with the elastic pieces 17a of the connector 12a and the elastic piece 27a of the connector 12b, and the two conductive pins 21 make and stay in contact with the elastic piece 17b of the connector 12a and the elastic piece 27b of the connector 12b, thus allowing the two conductive pins 21 to be connected to the positive and negative terminals of the power supply 51. Thus, the LED tube 20 can be driven by the LED drive circuit board 18 (shown in FIG. 8) by a current flowing from the positive terminal of the power supply 51, the LED drive circuit board 18, the conductive pin 21 of the LED tube 20 in connection with the elastic piece 17b of the connector 12a, LEDs in the LED tube 20 and the conductive pine 21 of the LED tube 21 in connection with the elastic piece 27b of the connector 12b to the negative terminal of the power supply 51.

When the LED tube 20 is rotated to make the two conductive pins 21 stay in contact with the elastic pieces 17a and 27d, and two insulated pins 22 stay in contact with the elastic pieces 17c and 27c, this causes one of the two insulated pins 22 to be connected to the negative terminal of the power supply 51, and one of the two conductive pins 21 to be connected to the Page of positive terminal of the power supply 51 via the ballast 53. Thus, the LED tube 20 cannot be driven by the LED drive circuit board 18 (shown in FIG. 9).

When the LED tube 20 is rotated to a position to make the two conductive pins 21 stay in contact with the elastic pieces 17a and 27a, and the two insulated pins 22 stay in contact with the elastic pieces 17b and 27b, this causes one of the two insulated pins 22 to be connected to the negative terminal of the power supply 51, and one of the two conductive pins 21 to be connected to the positive terminal of the power supply 51 via the ballast 53. Thus, the LED tube 20 cannot be driven by the LED drive circuit board 18 (shown in FIG. 10).

When the LED tube 20 is rotated to a position to make the two conductive pins 21 stay in contact with the elastic pieces 17c and 27c, and two insulated pins 22 stay in contact with the elastic pieces 17a and 27d, this causes one of the two conductive pins 21 to be connected to the negative terminal of the power supply 51, and one of the two insulated pins 22 to be connected to the positive terminal of the power supply 51 via the ballast 53. Thus, the LED tube 20 cannot be driven by the LED drive circuit board 18 (shown in FIG. 11).

Referring to FIGS. 12 and 13, when installing the fluorescent tube 20, the two pairs of pins can be respectively inserted into the through holes 16 of the connectors 12a and 12b. The fluorescent tube 20 can be rotated, and when the fluorescent tube 20 is rotated to the second position, the pins of the fluorescent tube 20 make and stay in contact with elastic pieces 17a and 17c of the connector 12a and the elastic pieces 27c and 27d of the connector 12b, allowing two of the pins of the fluorescent tube 20 to be connected to the positive and negative terminals of the power supply 51 respectively, wherein the pin connecting with the positive terminal of the power supply 51 is through the ballast 53. The starter 52 is connected between the other two pins of the fluorescent tube 20. Thus, the fluorescent tube 20 can be driven by the fluorescent drive circuit board 19 (shown in FIG. 12).

When the fluorescent tube 20 is rotated to a position whereby the two pairs of pins make and stay in contact with the elastic pieces 17a and 17b of the connectors 12a and the elastic pieces 27a and 27b of the connector 12b, this causes two of the pins of the fluorescent tube 20 to be connected to the positive and negative terminals of the power supply 51 respectively. But, the starter 52 is disconnected from the fluorescent tube 20. Thus, the fluorescent tube 20 cannot be driven by the fluorescent drive circuit board 19 (shown in FIG. 13).

FIG. 14 illustrates a connector 50 for the conventional fluorescent tube 20. Two elastic pieces 57a and 57b constituting an elastic member 17 are arranged around the through hole 16 in connector 50, and the lengths of the elastic pieces 57a and 57b are 0.5 A. The elastic pieces 57a and 57b are separated from each other by the opening 150 and by the second groove 151. The elastic pieces 57a and 57b are connected to the fluorescent tube drive circuit board 19.

The illumination device 1 may include the one connector 12 of FIG. 4 or FIG. 5 and one connector 50 of FIG. 14.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An illumination device comprising:
a light tube holder comprising:
a base;
a light-emitting diode (LED) tube drive circuit board mounted in the base;
a fluorescent tube drive circuit board mounted in the base;
first and second connectors arranged at opposite ends of the base for selectively receiving one of a fluorescent tube or an LED tube, the fluorescent tube comprising two conductive pins arranged on one end thereof and another two conductive pins arranged on an opposite end thereof, the LED tube comprising a conductive pin and an insulated pin being arranged on each end thereof, and the conductive pins arranged on opposite ends of the LED tube being diagonally opposite to each other;
wherein the first connector comprises:
a retainer defining a though hole;
a rotary member rotatably received in the through hole, and defining a first groove to receive two pins on one end of one of the tubes; and
three elastic pieces positioned in the retainer around the through hole, the three elastic pieces comprising a first elastic piece, a second elastic piece and a third elastic piece, the first and second elastic pieces electrically connecting with the LED tube drive circuit board, and the first and third elastic piece electrically connecting with the fluorescent tube drive circuit board;
wherein the second connector comprises:
a retainer; and
four elastic pieces comprising a fourth elastic piece, a fifth elastic piece, a sixth elastic piece and a seventh elastic piece received in the retainer of the second connector, in which the fifth and sixth elastic pieces electrically connect with a negative terminal of a power source and the seventh elastic piece electrically connects with a starter which is in turn electrically connected with the third elastic piece of the first connector, the first elastic piece being electrically connected with a positive terminal of the power source via a ballast and the second elastic piece being electrically connected with the positive terminal directly;
wherein when the rotary member of the first connector is rotated to a first position, the two pins on the one end of one of the tubes stay in contact with the first and second elastic pieces of the first connector, and the two pins on the opposite end of one of the two tubes stay in contact with the fourth elastic piece and the fifth elastic piece, respectively, and wherein when the one of the tubes is the LED tube, and the two pines on the opposite ends of the LED tube and connecting with the second and fifth terminals are the conductive pines, the LED tube is driven by the LED tube drive circuit board; and
when the rotary member of the first connector is rotated to a second position, the two pins on the one end of one of the tubes stay in contact with the second elastic piece and the third elastic piece, respectively, and the two pins on the opposite end of one of the tubes stay in contact with the sixth elastic piece and the seventh elastic piece, respectively, and wherein when the one of the tubes is the fluorescent tube, the fluorescent tube is driven by the fluorescent tube drive circuit board.

2. The illumination device as recited in claim 1, wherein the each of the elastic pieces has an arced configuration.

3. The illumination device as recited in claim 1, wherein an opening is defined in the retainer of the first connector and extends from an external lateral surface to a sidewall thereof surrounding the through hole, and communicates with the through hole.

4. The illumination device as recited in claim 3, wherein the first connector further comprising:
a second groove defined in the retainer thereof opposite the opening; and
at least one buffer pad formed on the side wall, between the opening and the second groove, the opening, the second groove, and the at least one buffer pad separate the first, second and third elastic pieces from each other.

5. The illumination device as recited in claim 4, wherein a length of the first elastic piece is about half of a perimeter of the through hole, and lengths of the second and third elastic pieces are both about a quarter of the perimeter of the through hole; the number of the at least one buffer pad is one; the first elastic piece, the second elastic piece, and the third elastic piece are separated from each other by the opening, the second groove and the buffer pad.

6. The LED illumination device as recited in claim 4, wherein the retainer of the second connector defines a through hole, the fourth, fifth, sixth and seventh elastic pieces are mounted around the through hole of the retainer of the second connector.

7. The LED illumination device as recited in claim 6, wherein lengths of the fourth, fifth, sixth and seventh elastic pieces are all about a quarter of the perimeter of the through hole of the retainer of the second connector.
